(19) United States
(12) Patent Application Publication
(10) Pub. No.: US 2016/0110808 A1
(43) Pub. Date: Apr. 21, 2016

(54) COMMODITY EXCHANGE FOR PRE-PURCHASING COMMODITIES AND TRADING FUTURE RIGHTS TO RECEIVE COMMODITIES

(71) Applicant: YINTAO YU, Mountain View, CA (US)

(72) Inventor: YINTAO YU, Mountain View, CA (US)

(21) Appl. No.: 14/918,279

(22) Filed: Oct. 20, 2015

Related U.S. Application Data
(60) Provisional application No. 62/065,885, filed on Oct. 20, 2014.

(51) Int. Cl. G06Q 40/04

(52) U.S. Cl. CPC G06Q 40/04

(57) ABSTRACT

A commodity exchange system enables trading and redemption of contracts of commodities with enhanced user experiences and functionalities. A user may pre-purchase a quantity of a commodity (e.g., gasoline) by purchasing a contract of the commodity at a currently traded price of the contract, which provides the user future rights to receive a quantity of the commodity at a strike price (which may be zero). The users may sell (or short sell/underwrite) these contracts through the commodity exchange system. The owner of a contract redeems the contract to obtain the commodity by transacting with a commodity supplier at the strike price, and original seller of the contract or an underwriter associated therewith pays the difference between a spot (market) price and the strike price upon redemption of the contract.

### CROSS REFERENCE TO RELATED APPLICATIONS

This application claims the benefit of U.S. Provisional Application No. 62/065,885, filed on Oct. 20, 2014, which is incorporated by reference in its entirety.

### BACKGROUND

The disclosure relates generally to the field of electronic commerce, and specifically to commodity exchange for pre-purchasing commodities, i.e., purchasing future rights to receive commodities, and trading and/or redemption of such rights, e.g., with new types of commodity contracts.

The development of commodity markets and trading systems has enabled many features to enhance the user experiences, for example, real-time or near real-time quotes and market access. The traded commodities are usually, for example, raw material, precious metals, agricultural products, and/or indices in relatively large quantities, to be delivered at a fixed time specified on the contracts of the commodities. However, the development of commodity markets and trading systems have a number of disadvantages that are still not yet resolved, including lack of services for users to buy, sell, or easily redeem contracts of a commodity (especially relatively small amount of consumer commodities), so that the users can hedge the risk of future price changes of commodities. The lack of such services, and in particular a commodity exchange service accessible via wired and wireless networks, leads to many inefficiencies in acquiring, trading, and redemption of commodity contracts.

### SUMMARY

Described embodiments enable trading (e.g., buy or sell) and redemption of contracts of commodities with enhanced user experiences and functionalities. A user of such services may pre-purchase a quantity of a commodity (e.g., gasoline) by purchasing a contract of the commodity at the currently traded price of the contract, which provides the user future rights to receive a quantity of the commodity. The traded price of a contract is also referred to as “contract traded price,” which is the market price of the contract at the time the contract is traded. For contracts that can be redeemed immediately after purchase (i.e., no “start time” is specified, or “start time” has passed), the traded price of a contract may be based on the underlying commodity's spot price, with additional time value depending on expiration time, risk/volatility, demand/supply, and other factors. For contracts that can be redeemed at a future time or period (not eligible for redemption immediately after purchase because a future “start time/date” is specified on the contract), the contract traded price usually reflects the market expectations of the spot price of the underlying commodity at a future time or period with additional time value depending on redemption period length, risk/volatility, demand/supply, and other factors. At any given time, a spot price of a commodity is the market price of the commodity to be delivered immediately (or close to immediately) in the spot market at that given time. A contract of a commodity may have an associated strike price, which is a pre-defined price upon the creation of the contract. A contract's strike price is part of the contract's specified parameters and is fixed during the lifetime of the contract. If a contract of a commodity does not specify the strike price, the strike price of the contract is equivalent to zero. A contract of commodity may become un-redeemable and worthless when the spot price of the commodity is lower than the contract's strike price. However, the contract may become redeemable (and thus have monetary value) again if the spot price of the commodity becomes higher than the contract's strike price before the contract's expiration time.

Embodiments also enable a user to sell (or short sell/underwrite) such contracts of commodities through a commodity exchange system. Depending on whether the contract's traded price has risen or lowered since the opening of the position, it may result in a capital gain or loss for the user. In the case of a realized capital loss (where “realized” means the open position has been closed), the user may be able to claim the loss in the user's personal income tax return or the entity/organization's tax return (if the user is an entity or organization). In accordance with embodiments of the invention, therefore, a commodity exchange system allows its users to trade (buy or sell) the rights to redeem commodities at a future time/period, in accordance with one or more specified parameters of the contracts of the commodities (e.g., type of commodity, quality, quantity, location/area, expiration time, begin time, strike price, etc., while some of the parameters may be optional).

In one embodiment, the owner of the contract transacts with a third-party supplier of the commodity (e.g., a gas station in the case of gasoline as the commodity) to redeem the contract. Upon the redemption, the commodity supplier provides the redeemer an amount of the underlying commodity pursuant to the contract. The commodity supplier is paid by the redemption system (which is connected to or is a part of the commodity exchange system) based on the spot price of the commodity at the redemption time (which may include a negotiated discount or other adjustments). The redemption system is compensated by the original seller of the contract (i.e., the seller of the contract when the contract was initially created, also known as the underwriter), or another party acquired the original seller's obligations under the contract, also based on the spot price of the commodity at the redemption time (which may also include a negotiated discount or other adjustments). The order of the two payment steps can be freely selected or the two steps can happen at the same time. The net effect of the two steps is effectively one step that the original seller (or underwriter) pays the commodity supplier in exchange for the commodity (provided to contract owner/redeemer) based on the spot price of the commodity at the redemption time, if negotiated discounts and adjustments are not included or do not exist.

In another embodiment, to redeem a contract, the contract owner purchases the underlying commodity from the commodity supplier based on the spot price of the commodity first, and then provides proof of the purchase (e.g., a receipt) to the redemption system for reimbursement. Once the proof is approved, the redemption system reimburses the redeemer also based on the spot price (which is the same as the purchase price) of the underlying commodity at the redemption time; and the original seller of the contract (i.e., the seller of the contract when the contract was initially created, also known as the underwriter), or another party acquired the original seller's obligations under the contract, is charged by the redemption system also based on the commodity's spot price at the redemption time. The contract owner/redeemer's commodity purchase step is the first step, and the order of the latter two payment steps can be freely selected or the two steps can happen at the same time. The net effect of the three steps is effectively one step that the original seller pays the commodity supplier in exchange for the commodity (provided to contract owner/redeemer) based on the spot price of the commodity at the redemption time. Beneficially, from the perspective of the redemption system and commodity exchange system, this embodiment does not require any cooperation or integration with the commodity supplier. From the perspective of the commodity supplier, in this embodiment, the redeemer is just the same as any other retail customers and they don't need to have the knowledge of, or, be aware of the commodity contract owned by the redeemer.

In various embodiments, the parties discussed herein (e.g., the redemption system/commodity exchange system, the commodity supplier, the contract seller, and the contract buyer/redeemer) may be the same or in privity with each other. For example, the contract original seller (aka underwriter) and the commodity supplier may be the same entity, whereby the commodity supplier uses the commodity exchange system as a platform for offering pre-purchases of its inventory of commodities. In this case, assuming that negotiated discounts and adjustments are not included or do not exist, the payment from the redemption system to the commodity supplier based on the spot price of the commodity and the compensation back from the contract original seller (also known as underwriter) to the redemption system also based on the spot price may be cancelled out against each other.

In another example, the commodity exchange system and the contract original seller may be the same entity or have a parent, branch, subsidiary or affiliate relationship (possibly with an information barrier to prevent conflicts of interest), and the commodity exchange system (also commodity contract seller in this example) and the commodity supplier may have negotiated for rates discounted from the (retail) spot price of the commodity.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a computing environment for trading and redemption of commodity contracts according to one embodiment.

FIG. 2 is a flowchart illustrating a process of trading a commodity contract according to one embodiment.

FIG. 3A is an example illustrating a user's capital loss near the expiration of a commodity contract, with respect to the time-series charts of the contract's traded price and the underlying commodity's spot price, according to one embodiment.

FIG. 3B is an example illustrating a user's capital gain near the expiration of a commodity contract, with respect to the time-series charts of the contract's traded price and the underlying commodity's spot price, according to one embodiment.

FIG. 4 is an example of a process of redeeming a contract of gasoline, according to one embodiment.

FIG. 5 is an example of a process of redeeming a contract of gasoline, according to another embodiment.

FIG. 6 shows examples of receipts of purchasing gasoline at various times, with various quantities and various grades.

FIG. 7 shows additional examples of receipts of purchasing gasoline at various times, with various quantities and various grades.

FIG. 8 shows an example of a redemption scene at a gas station, in which a sales receipt is captured as a proof of the purchase for reimbursement.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

### System Architecture and Commodity Contracts

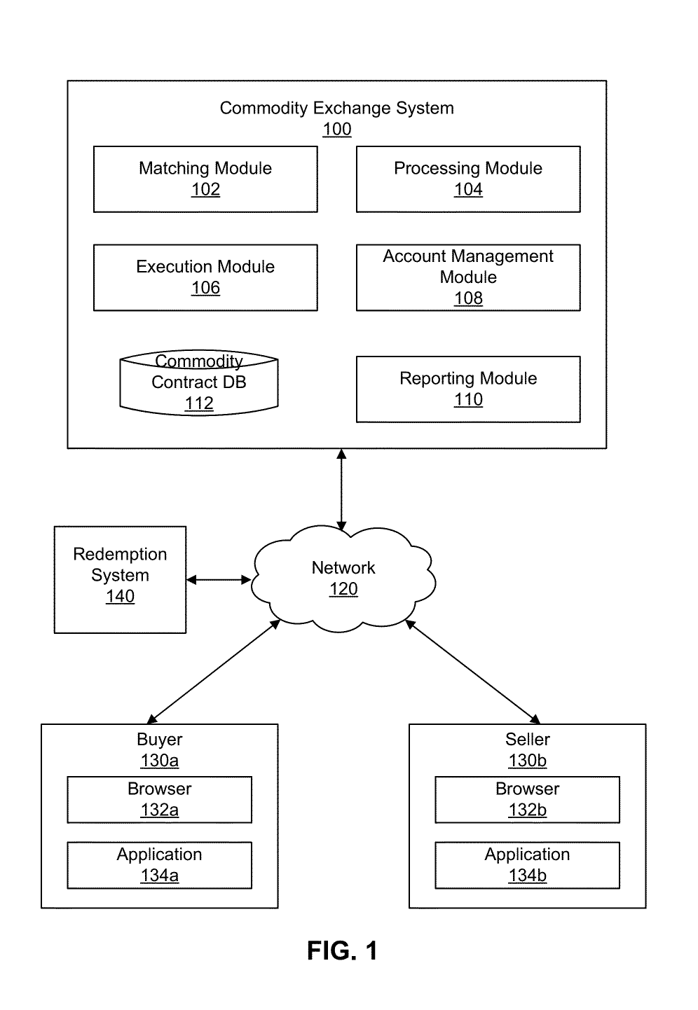

FIG. 1 is a block diagram of a computing environment for trading and redemption of commodity contracts according to one embodiment. The computing environment includes a commodity exchange system 100 in communication with a buyer 130a, a seller 130b, and a redemption system 140 over a network 120. The buyer 130a and the seller 130b buy or sell commodity contracts through the commodity exchange system 100. The buyer 130a (or contract owner) redeems his/her contracts of a commodity by using or connecting to the redemption system 140, which is connected to the commodity exchange system 100. Only one commodity exchange system 100, one buyer 130a, and one seller 130b are shown in FIG. 1 to simplify and clarify the description. Implementations of the computing environment can have many users (buyers 130a and/or sellers 130b), who are connected to the commodity exchange system 100 and the redemption systems 140 via the network 120. Likewise, the functions performed by the various entities of FIG. 1 may differ in different embodiments.

In this disclosure, “commodity” generally refers to any standardized products or services, tangible or intangible. Commodity can include, for example, gasoline (petrol), diesel, electricity, natural gas, water, any other utilities (TV, Internet, etc.), coal, metals (gold, silver, etc.), bullions, agricultural products (tomato, corn, banana, etc.), collectibles (coin, currency, stamp, etc.) with reasonable liquidity, and other products and services. Commodity can also be a piece of real estate. The measurement of real estates can be standardized in a variety of ways. For example, a real estate can be measured by the house/condominium's square footage, lot square footage (similar to volumes measured in gallons or liters for gasoline), with the specified parameters, for example, number of bedrooms, number of bathrooms, and location type (e.g., water front, non-water front, downtown area, etc., similar to the specified parameters such as gasoline grade/type, gas station location, etc. in gasoline contracts). The “commodity” in this disclosure may also refer to intangible services, for example, the annual tuition at a certain time or period at a certain educational institute, cable TV service at a certain area. For the purposes of simplicity and description of one embodiment, the commodity will be referred to as “gasoline,” but no limitations on the types of commodities are intended by this terminology. Thus, the operations described herein for exchanging contracts of gasoline can be applied to contracts of any type of commodities, including tangible and intangible, business and consumer products, real estates, and others.

In this disclosure, “contract”, or “commodity contract”, or “contract of a commodity” generally refers to an agreement between two parties who are engaged in the exchange of a right to receive a commodity. “Contract”, “commodity contract”, and “contract of a commodity” have the same meaning, and are interchangeable in this disclosure. By buying a contract of a commodity, the buyer obtains the right to receive the commodity; and by selling a contract of commodity, the original seller (also known as the underwriter) has the obligation to pay based on the spot price of the commodity or provide the commodity when the contract is redeemed. The contracts of commodities described herein are one type of financial security. The commodity exchange system 100 monitors a seller's account to check if the seller is at a risk of failing to fulfill the seller's obligations. The commodity exchange system 100 also guarantees the redemption of the contract, i.e. fulfilling seller's obligations, in the case that the original seller/underwriter fails to do so.

The parties of a trade transaction of such commodity contracts, e.g., the buyer 130a and the seller 130b, can be human users or entity/organization users (for simplicity, the parties are all referred to as users) of the commodity exchange system 100. Alternatively, one party of a trade transaction of a commodity contract can be the commodity exchange system 100 (or its parent, branch, subsidiary or affiliate entity). Thus, a user of the commodity exchange system 100 can trade against others users of the commodity exchange system 100 or against the commodity exchange system 100 itself. A user of the commodity exchange system 100 can buy, sell, or redeem a commodity contract through the commodity exchange system 100 and the redemption system 140.

In one embodiment, a contract of a certain commodity is described by one or more specified parameters. Examples of a certain commodity contract's specified parameters include the quality/grade of the commodity (for example, the grade of the gasoline/diesel such as 87 octane rating, 89 octane rating, 91 octane rating, diesel #1, diesel #2, etc.), the redeemable quantity of the commodity of one contract (e.g. one contract represents the quantity of one gallon), the redemption expiration time/date, the redemption start time/date, the location or locations/area where the contract can be redeemed, strike price, and any other information that can be used to describe the rights and obligations of contracting parties under the contract relative to the commodity of the contract. Two contracts having different sets of specified parameters are deemed different contracts and may not be treated as “substantially identical security”, for example, according to Internal Revenue Service (IRS) definition. Thus, selling one contract of a commodity at loss and buying another contract of the same commodity with different specified parameters immediately may not be treated as wash sale according to certain IRS rules. Examples of contracts of gasoline (or diesel) are: “This contract can be used to redeem one gallon of 91 grade gasoline at the Shell™ gas station at 2200 El Camino Real, Palo Alto, Calif. 94306 anytime on or before Dec. 15, 2014”, “This contract can be used to redeem one gallon of 87 grade gasoline at any BP™ gas station in Washington, D.C. anytime in December 2014 (any time between Dec. 1, 2014 and Dec. 31, 2014)” (with start time), and “This contract can be used to redeem one gallon of No. 2 diesel at any Chevron™ gas station in San Mateo county, California anytime on or before Dec. 15, 2014 at the extra cost of one US dollar” (with strike price).

An example of a contract of a bullion coin is: “This contract can be used to redeem a single, one-ounce U.S. Mint American Eagle gold coin (regardless of which year), anywhere in the world, forever”. An example of a contract of a collectible coin with reasonable liquidity is: “This contract can be used to redeem a single 1981 Chinese (People's Republic of China) 1 Fen aluminum coin produced by China's Shenyang Mint, graded MS-67 by PCGS™ or NGC™ or ANACS™, anywhere in China, forever”. PCGS™, NGC™, and ANACS™ are three major coin grading service providers. “MS” stands for Mint State and 67 is a grade number on a scale of 1 to 70.

An example of a contract of an agricultural product is: “This contract can be used to redeem one pound of tomatoes at any Walmart™ store in the state of Illinois” in March 2015 (any time between Mar. 1, 2015 and Mar. 31, 2015)”. Examples of contracts of real estates are: “This contract can be used to redeem one square foot of a non-waterfront single family house located in Foster City, Calif. 95128, anytime, forever”, and “This contract can be used to redeem a 10000 square feet lot (no house on the lot) in the town of Portola Valley, Calif. anytime from 2020 to 2030”.

An example of a contract of an intangible service is: “This contract can be used to redeem/cover one year's undergraduate tuition (at redemption time) at the University of California, Berkeley any time before 2025” and additional parameters may be in-state or out-of-state, strike price, etc. The location can be a set of schools, for example, any university in the University of California system, any Big Ten university, any Ivy League university, etc., and the contract can have an additional specified start time, e.g. any year between 2020 and 2025 (2020 is the start time). Another example of a contract of an intangible product is “This contract can be used to redeem one ticket (regardless which seat) to the Super Bowl game in 2020”. In all these examples, users can buy contracts now and lock the price at the current contract traded price, to hedge the risk of future price changes.

A buyer 130a uses a client device to trade commodity contracts with other users of the commodity exchange system 100 or directly with the commodity exchange system 100 itself. In one embodiment, the client device of the buyer 130a has a browser 132a and/or an application 134a. The buyer 130a uses the client device to buy or sell contracts of commodities by using the browser 132a or the application 134a, which communicates with the commodity exchange system 100; or redeem his/her contracts to receive commodities by using the browser 132a or the application 134a, which communicates with the commodity exchange system 100 and the redemption system 140. The buyer 130a uses the client device to review trade transactions, price quotes and other trade and account information by using the browser 132a or the application 134a.

Similarly, a seller 130b uses a client device to trade commodity contracts with other users of the commodity exchange system 100 or directly with the commodity exchange system 100 itself. In one embodiment, the client device of the seller 130b has a browser 132b and/or an application 134b. The seller 130b uses the client device to buy or sell contracts of commodities by using the browser 132b or the application 134b, which communicates with the commodity exchange system 100; or redeem his/her contracts to receive commodities by using the browser 132b or the application 134b, which communicates with the commodity exchange system 100 and the redemption system 140. The seller 130b uses the client device to review trade transactions, price quotes and other trade and account information by using the browser 132b or the application 134b.

A client device used by the buyer 130a or the seller 130b is an electronic device to perform functions such as executing applications and/or running browsers and other functions, so that the users can place orders to trade contracts, redeem contracts, view price quotes, trade transactions, and other trade and account information, and interact with various modules of the commodity exchange system 100 and the redemption system 140. For example, the client device may be a personal computer, a desktop computer, a laptop, a feature phone, a smart phone, or a tablet. The client device may include interfaces with a display device. In addition, the client device may provide a user interface (UI), such as physical and/or on-screen buttons, with which the user may interact with the client device to perform functions such as running the browser and/or executing the application, placing orders to trade contracts, viewing transactions and other information, and redeeming contracts, etc. In some embodiments, the users can place orders and perform other actions without using client devices, for example, by making phone calls to commodity exchange system 100.

Either the browser 132a/132b and/or the application 134a/134b can be used by the buyer 130a or the seller 130b to buy, sell, or redeem contracts of commodities through the commodity exchange system 100 and the redemption system 140. The network 120 enables communications between the commodity exchange system 100, the buyer 130a, the seller 130b, and the redemption system 140. The network 120 may be the Internet, another wide area network, a local area network, a wireless network, or the like. In some embodiments, a commodity supplier is connected to the network 120 to communicate with the redemption system 140, buyer 130a, and seller 130b; while in some other embodiments, the commodity supplier does not connect to the network 120 and the buyer/redeemer communicates with the commodity supplier directly. Various communication technologies and protocols for network implementation may be selected by the implementer from among conventionally known methodologies.

The redemption system 140 is a system configured to perform redemption of the contracts of commodities. In one embodiment, the redemption system 140 is not part of the commodity exchange system 100. In another embodiment, the redemption system 140 is a part of the commodity exchange system 100. In yet another embodiment, the redemption system 140 can partially belong to the commodity exchange system 100 and partially be outside of the commodity exchange system 100, e.g., at a gas station connected with the commodity exchange system 100. It is noted that in some embodiments, a user can allow certain other people to redeem the commodity contracts owned by him/her. For example, a user can allow his wife/husband/children/other family members to redeem the gasoline contracts owned by him/her; a business owner can allow his/her employees to redeem gasoline contracts owned by him/her or his/her company.

In one embodiment, the user swipes a card (similar to a debit card) issued by the commodity exchange system 100 at the gas station pump or gas station POS (Point of Sale) terminal to redeem the contract(s) of gasoline the user owns. The gas station is paid by the redemption system 140 by accepting a card of the user issued by the commodity exchange system 100. In another embodiment, upon the redemption, the user uses the application 134a/134b or the browser 132a/132b on the user's electronic device, e.g., a mobile phone, to generate a unique transaction number, or a bar code, or a Quick Response Code (QR code), or another type of code. The transaction number/bar code/QR code is generated based on the commodity contract(s) owned by the user that is going to be redeemed. The generated transaction number/bar code/QR code is scanned by the commodity supplier (e.g., a human works for the gas station, or a device at the gas station) and verified by the redemption system 140. The gas station is paid by the redemption system 140 by scanning a valid transaction number/bar code/QR code and sending such transaction number/bar code/QR code to the redemption system 140 to get verified. In yet another embodiment, the user uses the application 134a/134b or the browser 132a/132b on the user's NFC (Near Field Communication)-enabled mobile device to communicate with the gas station payment system to redeem the gasoline contract(s) the user owns. The gas station is paid by the redemption system 140 by receiving necessary information from the user's NFC-enabled mobile device and sending such information to the redemption system 140 to get verified.

In another embodiment, the user takes a photo of the sales receipt using his/her electronic device, e.g., a camera-equipped mobile phone. By using the application 134a/134b or the browser 132a/132b on the electronic device, the content of the receipt is recognized and verified, and the user is reimbursed accordingly based on the receipt. In some embodiments, optical character recognition (OCR) methods are used to recognize the content of the receipt. In one embodiment, the recognition is done at the client side (user's electronic device). In another embodiment, the photo is sent back to the redemption system 140, and the recognition is done at the server side (redemption system 140) and the server-side recognition can be further verified (or corrected) by human. In another embodiment, the recognition can be done at both the client side (user's electronic device) and server side (redemption system 140) for double verification. In some embodiments, the user's GPS location is also used to validate the redemption.

For example, a user has in total 10 contracts of certain grade gasoline (each contract's quantity is one gallon) eligible for redemption at a gas station. The user bought 15.5 gallons of gasoline at this gas station to fuel his/her car at $4 per gallon (paid $4/per gallon*15.5 gallons=$62), as shown on the sales receipt. With this receipt (15.5 gallons at $4/gallon), the user can chose to redeem all the 10 contracts he/she owned at this station, and user will be reimbursed $4/per gallon*10 gallons=$40, (regardless how much the user paid to buy these 10 contracts), leaving no remaining contracts at this gas station. Thus, the cost of 10 gallons is reimbursed, and the excessive quantity of gasoline (5.5 gallons) is paid by the user and not reimbursed. Alternatively, with this receipt, the user can choose to redeem, for example, 6 contracts he/she owned at this gas station, and the user will be reimbursed $4/per gallon*6 gallons=$24, leaving 4 remaining contracts at this gas station that can be redeemed or sold in the future. Thus, the cost of 6 gallons is reimbursed and the excessive quantity of gasoline (9.5 gallons) is paid by the user and not reimbursed.

Contracts can be partially redeemed, leaving a remaining quantity of contracts to be redeemed or sold later. For example, the user has in total 20 contracts of certain grade gasoline (each contract's quantity is one gallon) eligible for redemption at a gas station. The user bought 15.5 gallons of gasoline at this gas station to fuel his/her car at $4 per gallon (paid $4/per gallon*15.5 gallons=$62), as shown on the sales receipt. With this receipt, the user can redeem at most 15.5 contracts, and he/she will be reimbursed $4/per gallon*15.5 gallons=$62 (fully reimbursed), leaving 4.5 remaining contracts at this gas station that can be redeemed or sold in the future.

A contract can have a strike price. For example, the contract described as “This contract can be used to redeem one gallon of 91 grade gasoline at any Shell™ gas station in the city of San Francisco, Calif. anytime on or before Dec. 15, 2014 at the extra cost of three U.S. dollars” has a strike price of $3. This gasoline contract cannot be redeemed to receive gasoline alone, but must be redeemed together with extra cash. In this example, the owner of this contract can go to any Shell™ gas station in the city of San Francisco, Calif. before the contract expatriation time to redeem one gallon of 91 grade gasoline at the cost of $3, regardless how much the gas station's spot gasoline price is. This contract may become un-redeemable and worthless at a gas station when the gas station's spot price of 91 grade gasoline is below $3/per gallon. This is because if one can buy one gallon 91 grade gasoline directly for less than $3, it will cost more to pay $3 by redeeming the contract, making the contract useless. This contract, however, may become redeemable (and thus have monetary value) again if the gas station's spot price of 91 grade gasoline becomes higher than $3.

For example, in the embodiments that users need to take a photo of the receipt to redeem, a user has in total 10 such contracts of 91 grade gasoline with $3 strike price (each contract's quantity is one gallon) eligible for redemption at any Shell™ gas station in the city of San Francisco and the user bought 12.5 gallons of gasoline at an eligible gas station to fuel his/her car at $4.3 per gallon (paid $4.3/per gallon*12.5 gallons=$53.75), as shown on the sales receipt. With this receipt (12.5 gallons at $4.3/gallon), the user chose to redeem all the 10 contracts he/she owned and the user will be reimbursed $1.3/per gallon*10 gallons=$13, where $1.3 is from the paid spot price $4.3 minus the contract strike price (i.e. the price the user needs to pay) $3, (regardless how much the user paid to buy these 10 contracts), leaving no remaining contracts at this gas station. Thus, the cost above $3 of the 10 gallons is reimbursed, and the excessive quantity of gasoline (2.5 gallons) is paid by the user in full and not reimbursed.

In one embodiment, after the redemption system 140 receives a request for redeeming a contract of a commodity from a user of the commodity exchange system 100, the redemption system 140 instructs the commodity supplier to provide the underlying commodity described by the contract to the user, and the redemption system 140 compensates the commodity supplier. The commodity can be provided or delivered to the user in various ways, for example, shipping, or user pick-up, etc.

The commodity exchange system 100 enables trades of commodity contracts between users of the commodity exchange system 100, and/or between users and the commodity exchange system 100 (or its parent, branch, subsidiary or affiliate entities). In the embodiment illustrated in FIG. 1, the commodity exchange system 100 has a matching module 102, a processing module 104, an execution module 106, an account management module 108, a reporting module 110, and a commodity contract database 112. Other embodiments of the commodity exchange system 100 may have different and/or additional entities. Likewise, the functions performed by the various entities of the commodity exchange system 100 may differ in different embodiments.

The matching module 102 determines whether an order of a commodity contract matches one or more existing open orders of the same commodity contract based on some predefined business rules. Each order has an order type and other properties. The order type can be, for example, limit order, market order, pegged-to-midpoint order, stop order. Other properties of an order can be, for example, IOC (Immediate Or Cancel), FOK (Fill Or Kill), AON (All Or None), Add Liquidity Only, etc. The user can specify a time-in-force instruction to indicate how long an order will remain active before being executed or expired, for example, Day Order (which means the order is valid only for the current trading day, and the order or the unfilled part of the order will be expired at the end of the day), GTW (Good Till Week), GTM (Good Till Month), GTC (Good Till Cancel). It is noted that the order expiration time based on its time-in-force property is unrelated to the redemption expiration time of the commodity contract. The aforementioned order types and properties are widely accepted terms and well-defined in security trading.

In one embodiment, upon receiving a buy order of a commodity contract from a user, the matching module 102 checks if there is any existing open sell order(s) of the same commodity contract stored in the commodity contract database 112 with the same specified parameters. Similarly, upon receiving a sell order of a commodity contract from a user, the matching module 102 checks if there is any existing open buy order(s) of the same commodity contract stored in the commodity contract database 112 with the same specified parameters. Orders can be matched against each other only if they are of the same security, i.e. they are of the same commodity and of the same specified parameters (for example, expiration time, strike price, commodity grade, etc.). A buy order will be matched if it is a market order or its bid (buy) price is higher than the ask (sell) price of one or more existing open sell orders of the same security. Similarly, a sell order will be matched if it is a market order or its ask (sell) price is lower than the bid (buy) price of one or more existing open buy orders of the same security. The matching module 102 determines the matches and reports every matching result (matched quantity, price, time, etc.) to the execution module 106 to execute the trades.

An order can be partially filled, and can be traded against multiple orders. Responsive to no match being found for a new order, the matching module 102 stores this order associated with other related information (such as account information, order type, order expiration time, order received time, and other order properties) in the commodity contract database 112 for future trading. The order remains open until the order is fully filled, canceled by the user, or expired.

The processing module 104 receives a user's order of a commodity contract and determines whether the new order is accepted based on a set of business rules. In one embodiment, the processing module 104 determines whether the order is accepted based on the position(s) of the account, account net liquidation value, buying power, available funds, etc. In one embodiment, each account has an account profile, which includes the account's current positions of various commodity contracts, net liquidation value, buying power, available funds, etc. In one embodiment, to submit any new order/open any new position with margin, first, the account's net liquidation value has to be greater than or equal to certain threshold (for example $2000 per FINRA Rule 4210). Second, in order for the new order to be accepted, the account's available funds (net liquidation value minus initial margin requirement) after the new order request has to be greater than or equal to zero. If any of the two requirements is not met, this order will be rejected.

An account profile may also include reputation information of the account/user. In one embodiment, the reputation of the account/user identifies the account as creditworthy or not. Accounts of different levels of reputations have different permissions to different types of trading and/or different commodity contracts that can be traded. For example, an account with good reputation is deemed creditworthy and can short sell/underwrite certain commodity contracts, while regular accounts cannot short sell/underwrite commodity contracts. In another example, a creditworthy user can have one or more margin accounts, which allow the creditworthy user to magnify how much the user can buy or sell in the account, while initial margin requirements have to be met to open any new position with margin, and maintenance margin requirements have to be met to avoid margin calls.

Other business rules associated with the processing module 104 include the allowed trading counter-parties. In one embodiment, the contract buy and sell prices (or quotes) are determined by the commodity exchange system 100 (or its parent, branch, subsidiary or affiliate entities), and users of the commodity exchange system 100 can only trade against the commodity exchange system 100 (or its parent, branch, subsidiary or affiliate entities) at the given prices. In other words, users cannot send limit orders. In another embodiment, most individual users can only send market orders; and only certain power/creditworthy users can send limit orders with a specified limit price. Such power users can include, for example, commodity suppliers (for example, a gas station or a gas station chain for gasoline contracts, a university for tuition contracts), users/companies/entities whose net worth is above certain threshold, accounts whose net liquidation value is above certain threshold, and the commodity exchange system 100 itself or its parent, branch, subsidiary or affiliate entities. Thus, most individual users can only trade against power users/entities at market price. In yet another embodiment, any user of the commodity exchange system 100 can send limit orders with a specified limit price, and a user of the commodity exchange system 100 can trade against any other users of the commodity exchange system 100.

The execution module 106 interacts with the matching module 102 and the processing module 104, and executes trades. Upon a trade of a contract, if the seller previously owned such contract before the trade (net position>0), the ownership of the contract is transferred from the seller (previous owner) to the buyer (new owner), i.e. the right to receive a certain amount of certain commodity described by the contract is transferred. If the seller previously didn't own any such contract before the trade (net position<=0), upon the trade, the contract is newly created, and the buyer is the owner of the contract, and the seller is the original seller/underwriter of the contract who has to fulfill the contractual obligations. It is also noted that if the buyer previously had obligations to fulfill certain contractual obligations before the trade (net position<0), upon the trade, the buyer's obligations can be reduced or cancelled with the newly owned contract, if the newly owned contract is the same contract with the same specified parameters as the contract that buyer previously underwrote.

The commodity exchange system 100 can charge commission fee for each executed trade. The commission fee structure can be flat fee, a percent of the total traded value of a trade, or a combination of both. The commission fee can also depend on the volume a user trades and/or the traded order's liquidity type (e.g., adding liquidity or removing liquidity). For example, for a user who trades big volumes on a regular basis, that user may pay lower or discounted commission fees. The commodity exchange system 100 may also give out rebates to one party of the trade whose order is of certain liquidity type. A user of the commodity exchange system 100 may be able to choose which fee structure to use (select from e.g., flat fee, percent of the traded value, etc.). In some embodiments, the commodity exchange system 100 may not charge commission fee for all the trades, or certain types of trades, or certain types of users. The execution module 106 interacts with the account management module 108 upon completing a trade.

The account management module 108 manages user accounts and user profiles for users of the commodity exchange system 100. In one embodiment, a user may use a checking account, PayPal™ account, debit card, or credit card (additional fee may apply for debit/credit card) to fund his/her account at the commodity exchange system 100. A user of the commodity exchange system 100 may move the cash out of his/her account at the commodity exchange system 100 to his checking account, debit card, PayPal™ account or by requesting mailing a check. In one embodiment, the account management module 108 maintains the users' account information including available funds, positions, etc., and updates these information after each transaction such as executed trade, funding, and cash out. The account management module 108 may prevent money laundering through the commodity exchange system 100 using any of a variety of anti-money laundering mechanisms known to those of ordinary skill in the art, and meet anti-money laundering compliance requirements.

The reporting module 110 reports various types of information to the users of the commodity exchange system 100. The reporting module 110 may receive processing results (e.g., acceptance or rejection of an order from the processing module 104), execution results from the execution module 106 and account updates from the account management module 108, and report various results to the users of the commodity exchange system 100.

In one embodiment, after redeeming a commodity contract or closing a position of a commodity contract (e.g., sell a commodity contract to another party), with the user's permission, the commodity exchange system 100 may make social posts (such as status update, check-in, tweet, etc., which may include referral links) on behalf of the user to social networks, such as such as FACEBOOK™, TWITTER™, GOOGLE PLUS™, WEIBO™, etc. about the redemption or trade, to attract other users to use the commodity exchange system 100. These posts may include the amount the user saved or earned. In one embodiment, the user allows and keeps automatic social post permission in exchange of a reward (e.g., a chance to win certain credits in weekly sweepstakes). The commodity exchange system 100 may also encourage the users to voluntarily post on social networks with referral links to collect referral rewards.

In one embodiment, the commodity exchange system 100 may publish indices based on spot price of the commodities. For example, the commodity exchange system 100 may report an index based on average gasoline price per gallon of a particular gasoline grade at a particular gas station or in a certain area (e.g., a zip code, a city, a county, a state, a country, etc.). Thus, in a more concrete example, an index named “87 grade gasoline price index in the city of San Francisco” tracks the average 87 grade gasoline spot price per gallon in the city of San Francisco. This index is calculated and published in real time continuously (e.g. calculated and published once every 10 minutes). Other examples of indices published by the commodity exchange system 100 include the average price per square foot in a certain area (e.g., a neighborhood, a zip code, a city, a county, a state, a country, etc.), the median house sale price in a certain area, retail natural gas price per therm in a certain area, etc. The source of the data used to calculate such indices may be the data recorded from the commodity contract redemption events (this data source is owned by the commodity exchange system 100 itself), or from public records (e.g. house sale records from county's office), or from third party data provider. It is noted that the data recorded from the commodity contract redemption events and the data recorded from the commodity contract trading events can be very valuable. Such data can be sold to interested customers, possibly with built-in analytics tools.

Furthermore, volatility indices based on these spot price indices can be calculated and published too. For example, a volatility index based on the spot price index “87 grade gasoline price index in the city of San Francisco” is named “volatility index of 87 grade gasoline price in the city of San Francisco”, and provides a measure for variation of 87 grade gasoline spot price in the given area. Future contracts based on these spot price indices or volatility indices are also tradable contracts listed on commodity exchange system 100. Such index-based future contact's price generally converges to the corresponding index value upon expiration of the index-based future contract. It is noted that the index-based future contracts can be bought, or sold, or settled with cash, but cannot be redeemed for commodity, while the commodity contracts (with the rights to receive certain commodity) can not only be bought or sold but can also be redeemed for commodity.

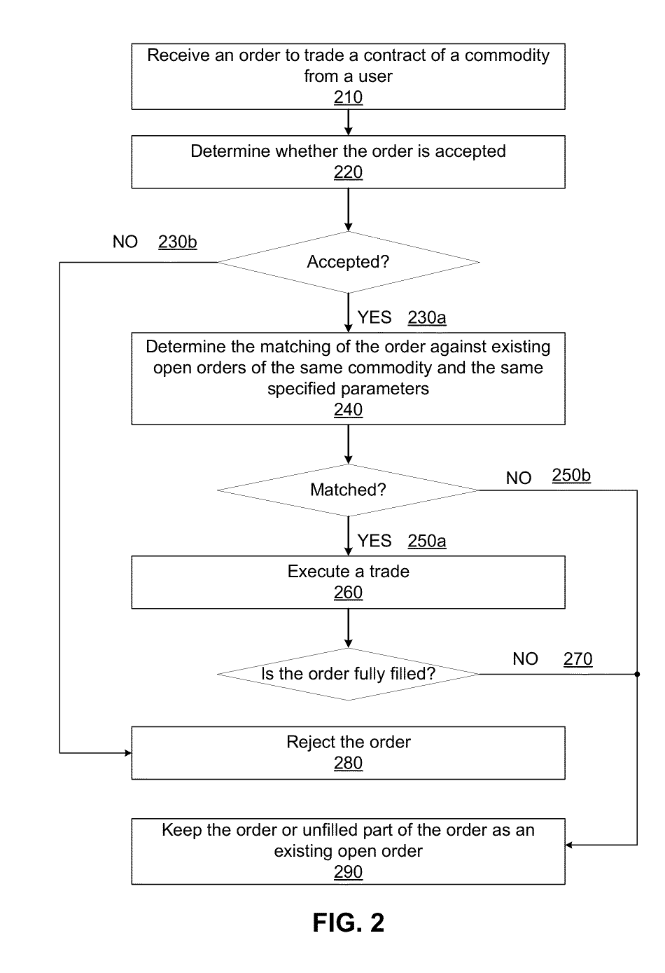

FIG. 2 is a flowchart illustrating a process of trading a contract of a commodity at the commodity exchange system 100 according to one embodiment. Initially, the commodity exchange system 100 receives 210 an order from a user (e.g., buy or sell order) to trade one or more contracts of a commodity (e.g., gasoline) and determines 220 whether the order is accepted. If the order is accepted, the commodity exchange system 100 then determine the matching of the order against existing open orders of the same commodity and the same specified contract parameters. For example, if the user's order is a buy order, the commodity exchange system 100 examines the best (lowest) sell price of the existing open sell orders of the same commodity and the same specified contract parameters. If the limit price of the user's buy order is greater than or equal to the best (lowest) sell price of the existing open sell orders of the same commodity and the same specified contract parameters, the commodity exchange system 100 determines that there is a match. A sell order can be similarly processed.

Responsive to no matches found 250b, the commodity exchange system 100 keeps 280 the order as an existing open order, until the order is cancelled or expired. If there is at least one existing open order matches 230a the order, the commodity exchange system 100 executes 260 the trade, i.e., transfers the ownership of the contract of a commodity from one party to another. If the order is not accepted, the commodity exchange system 100 rejects 280 the order and reports the rejection to the user.

Expiration Settlement with Open Position

The expiration date or expiration time of a commodity contract defines a time limit by which an owner of the contract can redeem the contract. If a contract of a commodity is not redeemed before the expiration date, the contract is in a state of expiration with open position. The commodity exchange system 100 may apply different sets of business rules for contracts in a state of expiration with open position.

In one embodiment, the owner of a contract will lose the right of the contract after the expiration of the contract and thus the owner will be forced to liquidate the contract or redeem the contract before expiration to prevent the contract from becoming worthless after expiration. In another embodiment, expired contracts will be settled in cash. A contract expiration settlement value will be determined by the commodity exchange system 100. Thus, if a contract is not redeemed before expiration, the owner of the unredeemed contract will receive payment in cash based on the settlement value, and the original seller (underwriter) of the unredeemed contract will be charged based on the settlement value. For example, the contract that “This contract can be used to redeem/cover one year's in-state undergraduate tuition (at redemption time) at the University of California, Berkeley any time before 2015” will be settled in cash with its settlement value equals to the University of California, Berkeley's in-state undergraduate tuition in the academic year of 2015-2016 when this contract expires right after the year 2015. (It does not matter whether the contract owner/redeemer goes to the University of California, Berkeley.)

In another embodiment, the commodity exchange system 100 automatically extends the original expiration date of the contract to a new expiration date and charges the owner of the contract an extension fee.

In one embodiment, the commodity exchange system 100 may charge the owner of an expired contract (long position) a “settlement with long position” fee for not redeeming the contract in time before expiration. For example, for commodities that are relatively easy to redeem, such as gasoline, an owner of an expired contract may be subject to be charged such “settlement with long position” fee for not redeeming the contract in time before expiration. In another embodiment, the commodity exchange system 100 may not charge a similar “settlement with short position” fee for sellers with expired contract (short position). It is noted that when or whether the contract will be redeemed is out of the seller's control, and the contract can be possibly redeemed by the owner in the last minute, clearing the seller's short position. In another embodiment, a “settlement with short position fee” may still exist, but can be smaller than the “settlement with long position” fee. It is noted that the owner (buyer) of the contract has two ways to close the long position before contract expiration: sell the contract, or redeem the contract. The underwriter (original seller) also has two ways to close the short position before expiration: buy the contract to cover the short position, or wait for the buyer of the contract to redeem, but when or whether the redemption will happen is out of the seller's control. The introduction of settlement fee is to encourage people to close position (redeem or liquidate) before expiration.

Before the expiration of a commodity contract, the owner of the contract can sell the contract through the commodity exchange system 100, or redeem the contract to receive a commodity (e.g., gasoline). A certain minimum redemption threshold may apply, depending on the type of commodity. For example, for gasoline, there can be no such minimum redemption threshold. For real estate, the minimum redemption square footage can be 500 square feet depending on various conditions. For gold, the minimum redemption quantity can be 1 ounce. Typically the higher cost/time/efforts to complete a redemption of a contract, the higher such redemption minimum threshold is required.

When a user sells a commodity contract that the user previously bought, or when the user buys a commodity contract to cover what the user previously short sold, the user closes a position and the user may experience a capital gain or a capital loss. The capital gain or capital loss is calculated as the difference between the contract traded price at the opening of the position (cost basis per contract) and the contract traded price at the closing of the position (proceeds per contract), multiplied by the traded volume of the commodity contracts. Upon the expiration time, the contract traded price should be typically very close to the spot price of the commodity (because the time value is exhausted), while it might be slightly lower or higher than the spot price of the commodity due to exchange trading fee, settlement with long/short position fee, lack of liquidity in the market (for example, users who don't want to redeem the contract before its expiration may have the motivation to rush to sell the soon-to-be expired contract, even at a slightly lower price than the underlying commodity's spot price).

The spot price of a commodity fluctuates over time, as the spot price may depend on public demand for the commodity, supply or projected supply of the commodity (e.g. crude oil production plan change), interest rate, war or conflicts, among other factors.

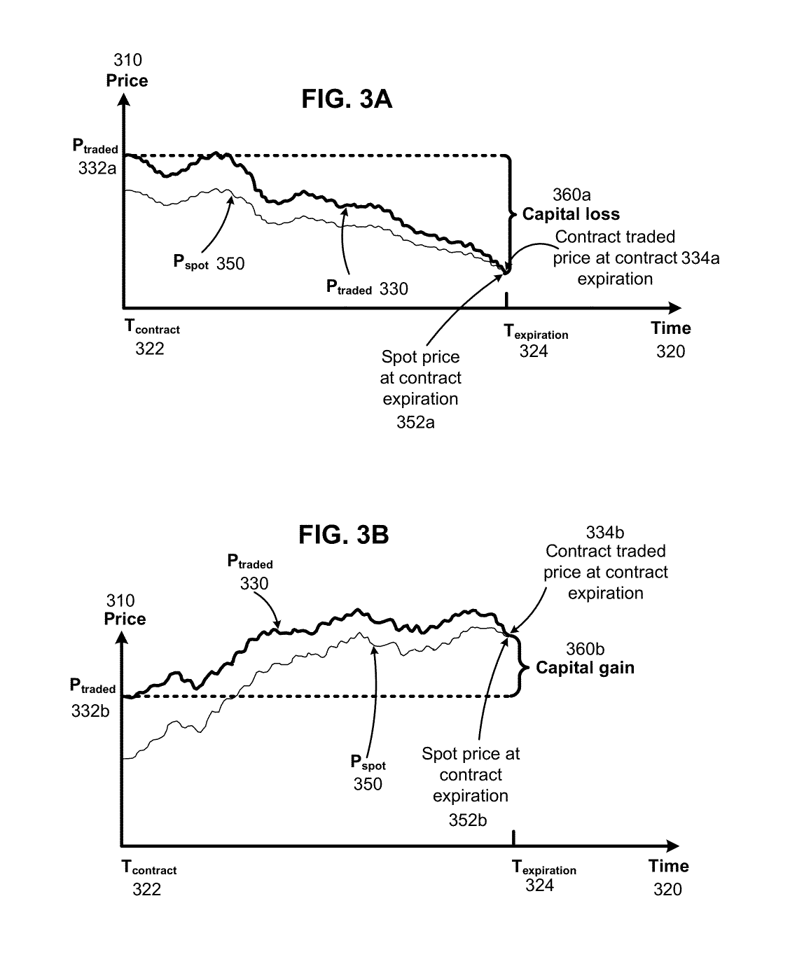

FIG. 3A is an example illustrating a user's capital loss near the expiration of a commodity contract, with respect to the time-series charts of the contract's traded price and the underlying commodity's spot price, according to one embodiment. The graph illustrated in FIG. 3A has a horizontal axis representing the time 320 and a vertical axis representing the price 310. At the initial purchase time of the contract 322, a user paid a contract traded price 332a for a commodity (e.g., 91 grade gasoline at $4.19 per gallon). The contract traded price 330 includes a time value (not shown in FIG. 3A and FIG. 3B, which is the difference between the contract traded price 330 and the spot price of the commodity 350), thus the contract traded price 330 is higher than the spot price of the commodity 350 at contract purchase time 322 and most of the time later. In this example, the spot price of the commodity 350 decreases over time towards the expiration time 324. When the contract is about to expire, if the user still owns this contract (not already sold or redeemed), the user can sell the contract at a price lower than the initial traded (purchase) price 332a. The user thus experiences a capital loss 360a, which is equal to the difference between the initial contract traded (purchase) price 332a and the contract traded price when the contract is sold, multiplied by the traded volume of the commodity contracts. If there is enough liquidity, and there is no or very little settlement with long/short position fee, the contract traded price at contract expiration time 334a should be very close to or the same as the spot price of the commodity at contract expiration time 352a.

In this example, the user (contract owner) has the options to redeem the contract for a commodity, or sell the contract to realize a capital loss. The user may prefer the second choice to realize a capital loss because it can provide tax benefits to the user by claiming capital loss. Another benefit by using the commodity exchange system 100 is the preservation of capital loss claim eligibility. According to IRS rules, a user cannot claim capital loss on the sale or trade of a security in a wash sale. A wash sale occurs when an individual sells or trades a security at a loss, and within 30 days before or after the sale at a loss, buys the same or substantially identical security. However, two contracts of the same commodity with different specified parameters, such as different qualities of the commodity (e.g. 87 grade gasoline versus 91 grade gasoline), different locations, different expiration time, may not be treated as substantially identical. Thus, the users of the commodity exchange system 100 may preserve the capital loss claim eligibility, by selling the contract to realize a capital loss, and purchasing a new (not identical) contract of the commodity immediately.

FIG. 3B is an example illustrating a user's capital gain near the expiration of a commodity contract, with respect to the time-series charts of the contract's traded price and the underlying commodity's spot price, according to one embodiment. Compared with the illustration in FIG. 3A, in FIG. 3B, when the contract is about to expire, if the user still owns this contract (not already sold or redeemed), the user can sell the contract at a price higher than the initial traded (purchase) price 332b. The user thus experiences a capital gain 360b, which is equal to the difference between the contract traded price when the contract is sold and the initial contract traded (purchase) price 332b, multiplied by the traded volume of the commodity contracts. In this example, the user (contract owner) has the options to redeem the contract for a commodity, or sell the contract to realize a capital gain. The user may prefer the first choice to redeem the contract because it may provide tax benefits to the user by avoiding capital gain tax. If the user chooses to redeem the contract for a commodity, in this example, since the spot price of the commodity is higher than the initial purchase price of the commodity contract, the user saves money by purchasing the commodity contract earlier instead of purchasing the commodity later at higher spot price.

It is noted that both FIG. 3A and FIG. 3B illustrate the capital loss or gain for the cases that purchasing a commodity contract first and selling the commodity contract later. A capital gain or loss can also be realized for the cases that short selling (i.e. underwriting) a commodity contract first and buying to cover the commodity contract later. On the other hand, the cases that short selling (i.e. underwriting) a commodity contract first and closing the short position later through counter-party's contract redemption may not realize capital gain or capital loss.

### Redemption of Contracts for a Commodity

When a user owns a contract of a commodity, the user can redeem the contract before the expiration date or expiration time if the user meets the redemption requirements given by the commodity exchange system 100. The redemption allows the user to receive commodities described by the contract (e.g., gallons of gasoline by redeeming gasoline contracts). If the contract has strike price, the user needs to pay at the strike price to receive the commodity, regardless of the spot price of the underlying commodity. If the contract does not have strike price, the user can receive the commodity without paying any extra money at redemption, regardless of the spot price of the underlying commodity.

In one embodiment, the user redeems an owned commodity contract at a commodity supplier, where the commodity supplier provides the amount of the commodity described in the commodity contract. The commodity supplier is paid by the redemption system 140 for providing the commodity to the user. In another embodiment, the commodity supplier also provides the amount of the commodity described in the commodity contract, but the user pays the commodity supplier first, and then gets reimbursed by the redemption system 140.

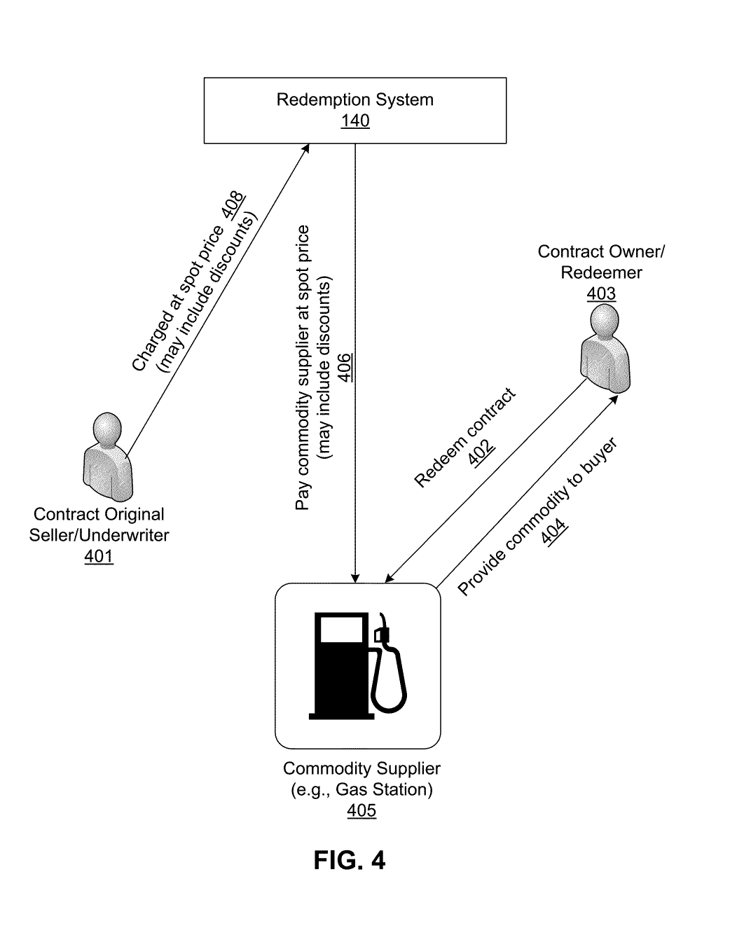

FIG. 4 is an example of a process of redeeming a gasoline contract according to one embodiment. The contract owner 403 has bought a gasoline contract. The ownership of the contract secures the right of redemption associated with the contract. At some point on or before the expiration time of the contract, the contract owner 403 redeems 402 the gasoline contract at a commodity supplier (a gas station) 405, which is connected to the redemption system 140. The gas station 405 is paid by the redemption system 104 at the gasoline spot price (may include discounts), and provides 404 the amount of gasoline described by the contract to the contract owner 403. If the gasoline contract has a strike price, upon redemption, the contract owner 403 also needs to pay the redemption system 140 based on the strike price of the contract to receive the gasoline.

In one embodiment, the contract owner 403 swipes a card (similar to a debit card) issued by the commodity exchange system 100 at the gas station pump or gas station POS (Point of Sale) terminal 405 to redeem the gasoline contract(s) the contract owner owns. The gas station 405 is paid by the redemption system 140 by accepting a card of the contract owner 403 issued by the commodity exchange system 100. In another embodiment, upon the redemption, the contract owner 403 uses the application 134a or the browser 132a on the user's electronic device, e.g., a mobile phone, to generate a unique transaction number, or a bar code, or a Quick Response Code (QR code)), or another certain code. The transaction number/bar code/QR code is generated based on the commodity contract(s) owned by the contract owner that is going to be redeemed. The generated transaction number/bar code/QR code is scanned by the commodity supplier 405 (e.g., a human works for the gas station, or a device at the gas station), and verified by the redemption system 140. The gas station is paid by the redemption system 140 by scanning a valid transaction number/bar code/QR code and sending such transaction number/bar code/QR code to the redemption system 140 to get verified.

In yet another embodiment, the contract owner 403 uses the application 134a or the browser 132a on the contract owner's NFC (Near Field Communication)-enabled mobile device to communicate with the gas station payment system to redeem the gasoline contract(s) the contract owner owns. The gas station is paid by the redemption system 140 by receiving necessary information from the contract owner's NFC-enabled mobile device and sending such information to the redemption system 140 to get verified.

In all the above three embodiments, the redemption system 140 pays the gas station based on the spot price of the gasoline at the time of redemption (may include certain negotiated discounts or adjustments), and charges 408 the original seller (aka underwriter) 401 of the gasoline contract also based on the spot price of the gasoline at the time of redemption (may also include certain negotiated discounts or adjustments). It is effectively that the gas station is paid by the original seller/underwriter 401 of the gasoline contract, based on the spot price of the gasoline at the time of redemption, if negotiated discounts and adjustments are not included or don't exist. If the gasoline contract has a strike price, upon redemption, the contract owner 403 also needs to pay the redemption system 140 based on the strike price of the contract to receive the gasoline; and the redemption system 140 charges 408 the original seller (aka underwriter) 401 of the gasoline contract based on the spot price of the gasoline at the time of redemption (may include certain negotiated discounts or adjustments) less the strike price.

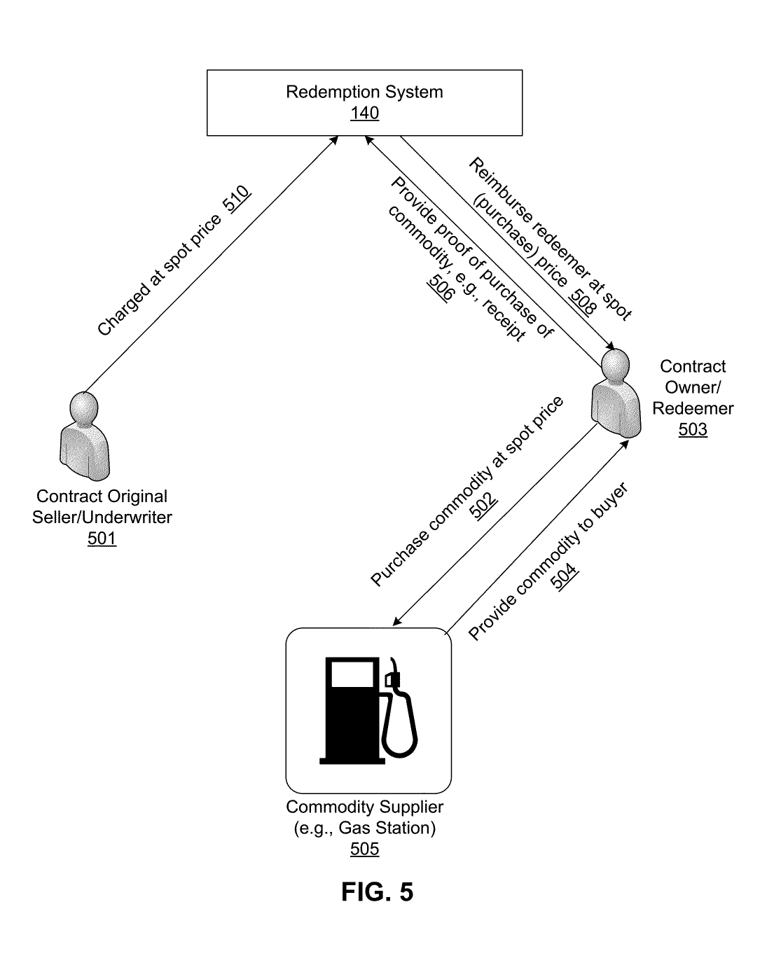

FIG. 5 is an example of a process of redeeming a gasoline contract according to another embodiment. In this example, the contract owner 503 purchases 502 gasoline from the commodity supplier (gas station) 505 based on the spot price of the gasoline first, and then provides 506 proof of the purchase to the redemption system 140 for reimbursement. Once the proof is approved, the redemption system 140 reimburses 508 the contract owner/redeemer 503 also based on the spot price (same as purchase price) of gasoline at the redemption time, and charges 510 the original seller/underwriter 501 also based on the spot price of gasoline at the redemption time. It is effectively that the gas station 505 is paid by the original seller/underwriter 501 of the gasoline contract, based on the spot price of gasoline at the time of redemption. Beneficially, from the perspective of the redemption system and commodity exchange system, this embodiment does not require any cooperation or integration with the commodity supplier (gas station). From the perspective of the gas station, in this embodiment, the redeemer is just the same as any other retail customers and they don't need to have the knowledge of, or, be aware of the commodity contract(s) owned by the redeemer. It is also noted that, in this embodiment, the contract owner/redeemer may receive cash back/points by using credit card to purchase upfront from credit card companies, as they will receive if they don't own/redeem any contracts.

The proof of the purchase can be a photo of the sales receipt, taken by the redeemer's electronic device, e.g., a camera-equipped mobile phone. By using the application 134a/134b or the browser 132a/132b on the electronic device, the content of the receipt can be recognized and such proof of purchase can be approved. Thus, the redeemer will be reimbursed accordingly based on the receipt. In some embodiments, optical character recognition (OCR) methods are used to recognize the content of the receipt. In one embodiment, the recognition is done at the client side (user's electronic device). In another embodiment, the photo is sent back to the redemption system 140, and the recognition is done at the server side (redemption system 140) and the server-side recognition can be further verified (or corrected) by human. In another embodiment, the recognition can be done at both the client side (user's electronic device) and server side (redemption system 140) for double verification. There can be an imposed time limit on the submission time of the sales receipt. For example, in some embodiments, the photo of the sales receipt has to be submitted within 15 minutes after the purchase (the purchase time is shown on the receipt) in order to be approved for reimbursement. In addition to the photo of the sales receipt, the proof of the purchase can also include the GPS location captured by the redeemer's electronic device (e.g. mobile phone) and/or the geotagging information contained in the submitted photo of the receipt (e.g. from the EXIF tag of the photo).

Taking FIG. 5 as an example, a contract owner 503 owns 10 gasoline contracts, and each contract has the following right: “This contract can be used to redeem one gallon of 87 grade gasoline at the Chevron™ gas station at 1399 Willow Road, Menlo Park, Calif. 94025 anytime on or before Dec. 15, 2014.” To make a valid redemption of all his 10 gasoline contracts, the contract owner 503 needs to go to that specified gas station on or before the contract expiration time, purchase 10 gallons or more of regular 87 grade gasoline, and take/submit a photo of the receipt. He/she may be required to take and submit the photo at the gas station within certain time limit (e.g. 15 minutes) after the gasoline purchase (instead of going somewhere else and/or submitting a photo of the receipt later). The content of the submitted receipt will be used to validate the redemption, and determine the reimbursement amount if approved. The GPS location captured by the redeemer's electronic device (e.g. mobile phone) and/or the geotagging information contained in the submitted photo of the receipt can also be used to validate the redemption.

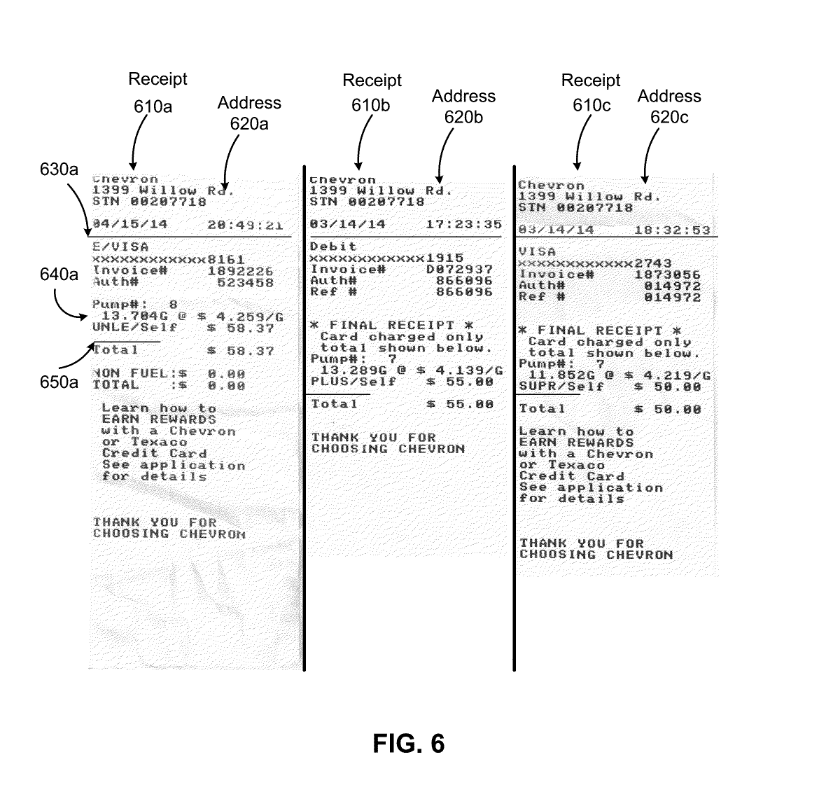

FIG. 6 shows examples of receipts of purchasing gasoline at various times, with various quantities and various grades. The three receipts, 610a, 610b, and 610c, in FIG. 6 are all obtained at the Chevron™ gas station at 1399 Willow Road, Menlo Park, Calif. 94025 (the gas station specified in this redemption example). The address of the gas station printed at the top of each receipt, e.g., 620a, together with the GPS location captured by the redeemer's electronic device or the geotagging information contained in the submitted photo of the receipt, is used to verify that the address of the gas station on the receipt is consistent with the captured GPS location/geotagging location, and such address is an allowed redemption location as specified in the contract. In this example, the allowed redemption location is fixed at the Chevron™ gas station at 1399 Willow Road, Menlo Park, Calif. 94025. If the allowed redemption address as specified in the contract is flexible, e.g. “any Chevron™ gas station in Santa Clara County, California”, the redemption system needs to verify if the printed address on the receipt and the captured GPS location/geotagging location are consistent, and are indeed an address of a Chevron™ gas station located in Santa Clara County, Calif. Right below the address, the time of the gasoline purchase, e.g., 630a, is printed on each of the receipts. The purchase time shown on the receipt and the redemption request submission time (the photo of the receipt is part of the redemption request) will be used to check whether the redemption request is submitted in time within certain time limit after the purchase (if any time limit on redemption request submission is required). The photo taken time information that can be extracted from the submitted photo (e.g. from the EXIF tag of the photo) can be also used as an additional validation of the time limit requirement.

The last four digits of the credit card/debit card shown in the receipts can be used as an additional/optional verification of the identity of the redeemer. Additionally, the redeemer can register credit card numbers/debit card numbers that he/she will be used to purchase gasoline in advance at the redemption system/commodity exchange, and upon the approval of a redemption, the reimbursement amount can be credited back to the card that the user used to purchase the gasoline in this transaction (or can be credited to another account/card or the user's default account, based on user's settings). The invoice number, authentication number and reference number shown in the receipts can be used to verify the legitimacy of the receipt, if the redemption system can check with the commodity supplier (Chevron Corporation in this case).

The grade of the purchased gasoline, e.g., 650a, the quantity of gasoline purchased in gallons, e.g., 640a, and the purchase price of the gasoline per gallon, as well as the total amount paid are shown in each of the receipts. From left to right, the grades of the gasoline are printed as UNLE (Regular Unleaded, which means regular 87 grade), PLUS (Plus Unleaded, which means 89 grade), and SUPR (Supreme Unleaded, which means 91 grade). In this example, since the contract owner owns 10 contracts of 87 grade gasoline contracts to be redeemed, receipt 610a in FIG. 6 can be a valid receipt if submitted (assuming other requirements such as GPS location, submission time are met), while the other two receipts (receipt 610b shows 89 grade gasoline purchase, and receipt 610c shows 91 grade gasoline purchase) in FIG. 6 cannot be used to validate the redemption of the 87 grade gasoline contracts because 87 grade gasoline contracts can only be used to redeem 87 grade gasoline.

If receipt 610a in FIG. 6 is submitted for redemption/reimbursement, assuming other requirements (e.g. GPS location, submission time, etc.) are met, this receipt can prove that the contract owner/redeemer bought 13.704 gallons of 87 grade gasoline at this Chevron™ gas station to fuel his/her car at $4.259 per gallon (paid $4.259/per gallon*13.704 gallons=$58.37), as shown on the sales receipt. In this example, since the redeemer has in total 10 contracts of 87 grade gasoline contract (each contract's quantity is one gallon) eligible for redemption at this Chevron™ gas station, with this receipt (13.704 gallons at $4.259/gallon), the redeemer can chose to redeem all the 10 contracts he/she owned at this Chevron™ gas station, and the redeemer will be reimbursed $4.259/per gallon*10 gallons=$42.59, (regardless how much the contract owner/redeemer paid to buy these 10 contracts), leaving no remaining contracts at this Chevron™ gas station. Thus, the cost of 10 gallons is reimbursed, and the excessive quantity of gasoline (3.704 gallons) is paid by the redeemer and not reimbursed. (If the contract owner/redeemer just want to redeem the 10 one gallon gasoline contracts without buying any extra amount, he/she can purchase exactly 10 gallons of gasoline and submit the receipt.) Alternatively, with this receipt 610a, the redeemer can choose to redeem, for example, 6 contracts he/she owned at this Chevron™ gas station, and the redeemer will be reimbursed $4.259/per gallon*6 gallons=$25.55, leaving 4 remaining contracts at this Chevron™ gas station that can be redeemed or sold in the future. Thus, the cost of 6 gallons is reimbursed and the excessive quantity of gasoline (7.704 gallons) is paid by the redeemer and not reimbursed.

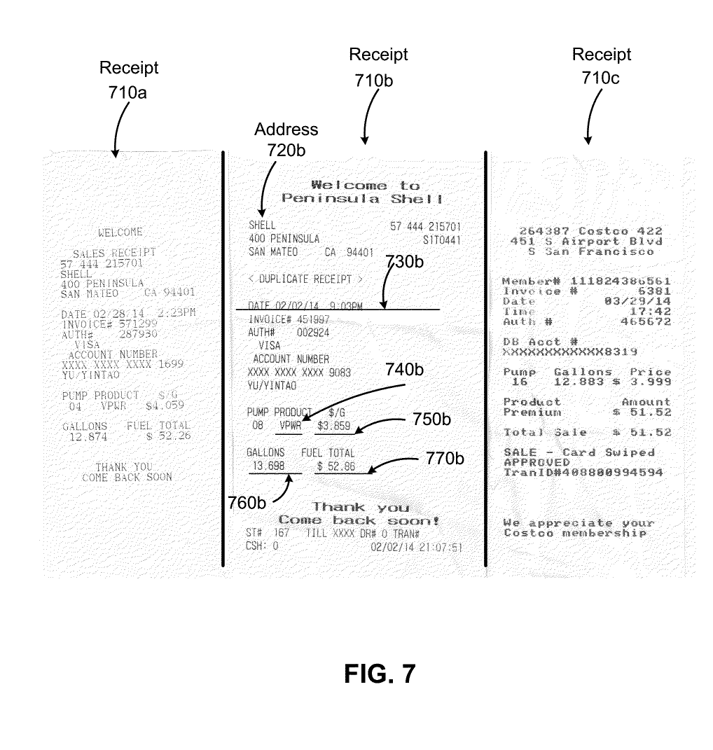

FIG. 7 shows more examples of photos of receipts, from a Shell™ gas station and a Costco™ gas station. Receipt 710a and receipt 710b are from a Shell™ gas station. Receipt 710b is a re-print receipt (duplicate receipt) obtained at the gas station's convenient store, in the case that the redeemer fails to or forgets to obtain the receipt at the pump. Similar to the receipts from Chevron™ gas station in FIG. 6, all the three receipts in FIG. 7 show the address of the gas station (e.g., 720b), the purchase time (e.g., 730b), the grade of the purchased gasoline (e.g., 740b), the quantity of gasoline purchased in gallons (e.g., 760b), and the purchase price of the gasoline per gallon (e.g., 750b), as well as the total amount paid (e.g., 770b). On receipt 710a and receipt 710b from a Shell™ gas station, the gasoline grade “VPWR” (V-power) means 91 grade gasoline. On receipt 710c from a Costco™ gas station, the gasoline grade “Premium” also means 91 grade gasoline. Receipt 710a and receipt 710b from Shell™ gas station also display the credit card holder's name, which can be used as an additional/optional verification of the identity of the redeemer. Similarly, the Costco™ membership number on receipt 710c from Costco™ gas station can also be used as an additional/optional verification of the identity of the redeemer.

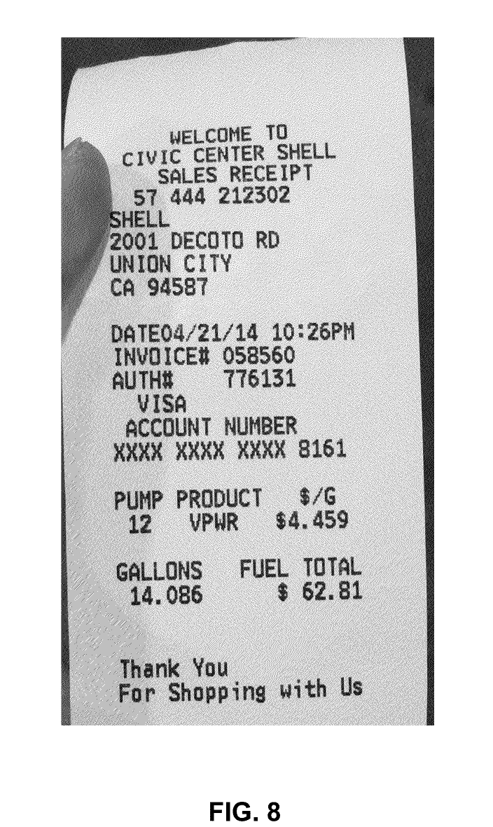

FIG. 8 shows an example of a redemption scene at a gas station, in which the redeemer holds a receipt and captures a photo of the receipt using a camera-equipped cell phone right after fueling. The photo of the receipt is used as a proof of purchase for reimbursement.

To reduce the chance of illegitimate/modified receipts submitted from dishonest users. The redemption system/commodity exchange system can require the redeemer to use the application 134a/134b only to capture the receipt photo, and the application 134a/134b will submit/upload the receipt photo to the redemption system automatically and immediately (or almost immediately). Thus, a user cannot submit an existing receipt photo on their electronic device which was taken earlier. This can help to prevent the case that a dishonest user can take a receipt photo first, then modify it, and then submit the modified receipt photo. The redemption system 140 can also verify the legitimacy of the receipt by using the invoice number and checking with the commodity provider (gas station). The redemption system 140 can also have fraud detection mechanism to determine if the purchase price on a submitted receipt is fraudulent. If the per gallon purchase price on a submitted receipt is significantly higher than the purchase price of the same grade gasoline at the same (or nearby) gas station(s) around the same time (obtained from other redeemers' submissions at the same/nearby gas station around the same time), or significant higher than the purchase price of the same grade gasoline at the same gas station at the same time based on other data sources, the receipt will be determined illegitimate and the redemption/reimbursement will not be approved unless further supporting evidences are provided.

In one embodiment, a contract owner/redeemer gets reimbursed based on a fair spot price of the gasoline for the contract specified grade at the redemption request time and at the redemption location. For example, if a receipt photo is required for redemption, but the redeemer does not submit a receipt photo or the submitted receipt photo is not readable/recognizable, the redeemer will get reimbursed based on a fair spot price of the gasoline for the contract specified grade at the redemption request time and at the redemption location. In such scenario, without a receipt photo, a captured GPS location is required to validate the redemption location. The gasoline fair spot price depends on the gasoline grade, redemption (purchase) time, and gas station location.

The gasoline fair spot price can be determined by the purchase prices of the same grade gasoline from other redeemers' submissions at the same/nearby gas station(s) around the same time, or the purchase price of the same grade gasoline at the same gas station at the same time based on other data sources. Such fair spot price should be very close to the actual purchase price the redeemer paid, if not exactly the same. It is also noted that, in certain rare cases, if the requested spot price in a redemption request is significantly higher than a fair spot price, even if a genuine receipt is submitted (if a receipt is required, such as the case in FIG. 5), or the spot price is provided by the commodity provider (a receipt is not required, such as the case in FIG. 4), the redemption system 140 may still disapprove the redemption request with the requested spot price, but can only reimburse the redeemer (the case in FIG. 5) or the commodity supplier (the case in FIG. 4) based on a fair spot price. For example, given that all the nearby gas stations have 87 grade gasoline for around $4 per gallon, a certain gas station raises the 87 grade gasoline price to $8 per gallon, and a contract owner requests to redeem at this gas station at the manipulated $8 per gallon price, the redemption system 140 detects a price manipulation of the commodity supplier and refuses to reimburse/redeem at $8 per gallon but can only reimburse/redeem at a fair spot price (around $4 per gallon) of the gasoline. A repeat price manipulator will be restricted/banned (cannot redeem at this gas station, cannot trade commodity contracts on this gas station).

To prevent and discourage price manipulation and insider trading, for gasoline contracts, a person working at a gas station or a gasoline company is treated as an insider, and such person is not allowed to trade a set of the contracts with conflict of interest at the commodity exchange system. A maximum amount of gasoline (measured in gallon or liter) that a single person can redeem at a single gas station in one day (aka daily cap) may also apply. For tuition contracts, the insiders are the related staff and board members of the school. Additionally, to prevent insider trading, for example, the contract that “This contract can be used to redeem/cover one year's in-state undergraduate tuition at the University of California, Berkeley in the academic year of 2018-2019” will stop trading a few months before the board discusses and decides the tuition of 2018-2019 academic year. Similar “stop trading” property may apply to other contracts.

Redemption without Redeemer's Interaction with Commodity Suppliers

In some embodiments, for contracts of certain types of commodities, to redeem a contract, the contract owner may not be allowed to receive the commodity from a commodity supplier (as the redemption process illustrated in FIG. 4), or buy from a commodity supplier first and get reimbursed (as the redemption process illustrated in FIG. 5). Instead, the contract owner sends a redemption request first, and then the commodity will be provided to the contract owner/redeemer by the redemption system 140 or the contract original seller/underwriter. The redemption process can be generally done in one of the three ways (or in mixed ways): 1) the redemption system 140 acquires the underlying commodity, provides the commodity to the contract owner/redeemer, and charges the contract original seller/underwriter the acquisition cost; 2) the contract owner/redeemer acquires the underlying commodity and provides the commodity to the contract owner/redeemer; and 3) the contract owner already owns the underlying commodity before the contract owner/redeemer's redemption request, and simply provides the commodity to the contract owner/redeemer after the redemption request.

As an example of the first way, Alice bought 6000 contracts that “each contract can be used to redeem one square foot lot (no house on the lot) in the city of Palo Alto, Calif. by the year of 2050”, at the price of $100 per contract in 2010. The original seller/underwriter of the 6000 contracts is Bob, but Bob doesn't own such underlying commodity (lot in Palo Alto). The total cost was $600,000 paid by Alice to Bob through commodity exchange system.

In 2014, such contract is traded at $150 per contract. Alice can sell the contracts she owns for a profit to someone, or she can choose to redeem her contracts. If Alice chooses to redeem her 6000 contracts, after she sends the redemption request, the redemption system will try to buy a lot in Palo Alto which is close to 6000 square feet on behalf of Alice from the Palo Alto real estate market, within certain time limit (e.g. 3 months, because real estate market is not very liquidate and the redemption is not guaranteed to be fulfilled soon). The lot that the redemption system acquired for Alice may not be precisely 6000 square feet, but can be within certain allowed range (e.g. 10% more or less square footage is allowed, i.e. the allowed range is from 5400 square feet to 6600 square feet). It turned out the redemption system acquired a 5800 square feet lot in Palo Alto with the acquisition cost $860,000. It is noted that the acquisition cost per square footage is close to but not exactly the same as the contract current traded price $150 ($150*5800 would be $870,000). Thus, Alice will be given the 5800 square feet lot, with 200 remaining unredeemed contracts still owned by her. Bob will be charged the $860,000 acquisition cost, and he still has a short position of −200 contracts. Bob can buy 200 contracts at $150 per contract now to cover his short position, and similarly Alice can sell her remaining 200 contracts at $150 per contract now to close her remaining long position. If the redemption system acquired a 6200 square feet lot at the acquisition cost of $950,000 (larger than 6000 square feet, over-redeemed), Alice will need to pay the prorated extra cost of 200 square feet for $950,000/6200*200=$30,645 to receive the lot, and Bob will be charged the prorated acquisition cost $950,000/6200*6000=$919,355, and both Alice and Bob will have no remaining position after the 6200 square feet is given to Alice (“redemption”). It is also noted that there can be a minimum redemption quantity and a maximum redemption quantity in one redemption request. For example, to redeem a real estate lot, the minimum redemption square footage can be 5000 square feet, depending on various conditions. For gold, the minimum redemption quantity can be 1 ounce.

In another example with mixed ways, Alice has a one-ounce U.S. Mint American Eagle gold coin. She sold 0.5 contract which states that: “This contract can be used to redeem a single, one-ounce U.S. Mint American Eagle gold coin (regardless of which year), forever” to Bob for $1200 per coin in 2010, i.e. Bob paid $600 to Alice for the 0.5 contract via commodity exchange system. Thus, half of the ownership of the coin Alice owned is essentially transferred to Bob. Bob bought another 0.5 contract (the same U.S. Mint American Eagle gold coin contract) from Charles in 2011 for $1500 per coin in 2013, i.e. Bob paid $725 to Charles for the 0.5 contract via commodity exchange system. Charles doesn't own any such coin.

Now in 2014, the current spot price of the coin is $1400 per coin. Bob requests to redeem the one contract he owns to receive a coin. Alice sends her coin to the redemption system 140, and the redemption system 140 verifies the authenticity of the coin and sends it to Bob (or Alice sends the coin directly to Bob with 3^{rd} party authentication.) Alice also receives $700 (0.5*current spot price $1400) for the half of the coin that she didn't sell upon sending her coin, and Charles is charged $700 to close his short position of −0.5 contract. Charles thus has a capital gain of $25 after the redemption (Charles received $725 in 2013, and is later charged $700 in 2014, making $25). Bob paid in total $1325 for the coin ($600 in 2010 to Alice and $725 in 2013 to Charles). Alice essentially sold half of her coin for $600 in 2010 and the remaining half for $700 in 2014. It is noted that after Bob sends the redemption request, Alice can choose to buy back 0.5 contract at the commodity exchange to keep her coin. If so, the redemption system 140 (or Charles) will then need to acquire a coin from the bullion market for Bob. It is noted that, for certain commodities, the contract owner/redeemer can be charged a shipping cost/handing fee for contract redemption. Alternatively, the contract owner/redeemer may not need to pay the shipping cost/handling fee when redeeming the contract, and such cost may be already included in the contract price when a user buys the contract. Also, for certain commodities, the contract owner/redeemer can go to an authorized local store (e.g. an authorized local gold dealer for gold coins) to pick up the commodity.

To provide more flexibility for consumers, the commodity exchange system 100 may allow its users to convert a contract of a commodity to another related contract of a commodity directly or indirectly. For example, a contract owner can convert a contract of gasoline described as: “This contract can be used to redeem 1 gallon of 91 grade gasoline at the Shell™ gas station at 2200 El Camino Real, Palo Alto, Calif. 94306 on or before Dec. 15, 2014,” to another contract described as: “This contract can be used to redeem 1 gallon of 91 grade gasoline at the Shell™ gas station at 400 Peninsula Avenue, San Mateo, Calif. 94401 on or before Aug. 15, 2014.” In this example, the conversion of the contract moves the same grade gasoline from one gas station in Palo Alto to another gas station in San Mateo with a shortened expiration time. The conversion of the contract can also be at the same gas station, but between different grades or with shortened/extended expiration time. In the case that a gas station is closed or changed, the commodity exchange system may help to convert the gasoline contract to one or more nearby gas stations on a case by case basis.

The contract conversion rate may be determined by the commodity exchange system 100 or determined by a conversion marketplace formed by the users and/or commodity suppliers. Generally, converting a commodity contract from a higher-priced area to a lower-priced area and/or shortening the expiration time can yield a conversion rate larger than one and vice versa. In the example of gasoline contracts, if some gas stations or a chain of gas stations want to offer certain promotions, these gas stations can encourage contract owners to convert their gasoline contracts at other gas stations to their gas stations at a promotional conversion rate. Such promotional conversion rate can be a rate negotiated between the commodity exchange system and the gas stations running promotions.

On the other hand, the contract owners can indirectly convert their commodity contracts by selling the contracts they no longer want to own for cash, and then buy the commodity contracts they want.

A contract conversion can also be achieved by trading a conversion right contract. A conversion right contract on the commodity exchange system 100 is to some extent similar to a two-leg spread in finance, but not the same. A conversion right contract can be, for example, “This contract provides the right to convert one gallon grade 91 gasoline contract at any Shell™ gas station in Palo Alto, Calif. to any Shell™ gas station in San Mateo, Calif. by 2015 with the contract expiration time unchanged”. Since the gasoline price is higher in Palo Alto than in San Mateo in general, the price of such contract is likely to be negative. Thus, the user buys this conversion right contract will also receive some money (like opening a short position). After owning both the conversion right contract that “This contract provides the right to convert one gallon grade 91 gasoline contract at any Shell™ gas station in Palo Alto, Calif. to any Shell™ gas station in San Mateo, Calif. by 2015 with the contract expiration time unchanged”, and the gasoline contract that “This contract can be used to redeem 1 gallon of 91 grade gasoline at the Shell™ gas station at 2200 El Camino Real, Palo Alto, Calif. 94306 on or before Dec. 15, 2014”, the user can combine them and generate a new contract that “This contract can be used to redeem 1 gallon of 91 grade gasoline at any Shell™ gas station in San Mateo, Calif. on or before Dec. 15, 2014”. It is noted that after the new contract is generated, the user's two previous owned contracts will be cleared and such combination process sometimes cannot be reverted (while sometimes can). It is also noted the conversion right contract's expiration time (2015 in this example) is independent from the to-be-converted commodity contract's expiration time (Dec. 15, 2014 in this example).

Selling the conversion right contract that “This contract provides the right to convert one gallon grade 91 gasoline contract at any Shell™ gas station in Palo Alto, Calif. to any Shell™ gas station in San Mateo, Calif. by 2015 with the contract expiration time unchanged” is equal to buying the inverted version of the same conversion right contract, which is described as “This contract provides the right to convert one gallon grade 91 gasoline contract at any Shell™ gas station in San Mateo, Calif. to any Shell™ gas station in Palo Alto, Calif. by 2015 with the contract expiration time unchanged”, and will generally cost some money, given that the gasoline price is generally higher in Palo Alto than San Mateo.

A few other examples of conversion right contracts are: “This contract provides the right to convert a one gallon gasoline contract at any Chevron™ gas station in Mountain View, Calif. to any gas station in Santa Clara County by 2020, with grade and contract expiration unchanged” (which can broaden the eligible redemption area; the to-be-converted contract can be a single location gasoline contract at one Chevron™ gas station in Mountain View, or a gasoline contract eligible at multiple Chevron™ gas stations in Mountain View, as long as its eligible redemption locations include any Chevron™ gas station in Mountain View), and “This contract provides the right to extend the expiration time of a one gallon gasoline contract in California by a month, with grade and eligible location unchanged”. All these conversion right contracts are tradable contracts listed on the commodity exchange system 100, and users can buy and sell them immediately without using them to convert an existing commodity contract.

It is noted that, to hedge the risks, the buyers and sellers of the commodity contracts may buy, sell and store the underlying commodities (e.g. buy/sell/store gold, buy real estates) or buy, sell related commodity futures/derivatives on other markets (e.g. buy/sell gold future contracts on CME™). For example, given the prices of consumer gasoline and crude oil are correlated, an underwriter/seller of consumer gasoline contracts may buy crude oil future contracts in large quantities on other future exchanges (NYMEX™ which is part of CME™, ICE™, etc.), while selling many consumer gasoline contracts (typically in relatively small quantities) on the commodity exchange system 100 to hedge the risks.

### General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

What is claimed is:

1. A computer-implemented method for managing a contract for a commodity, the method comprising:
maintaining in a data store information describing a contract for a commodity, the contract entitling an owner of the contract to redeem the contract to obtain a specified amount of the commodity from a merchant business establishment at a strike price, the contract further obligating an original seller of the contract or an underwriter associated therewith to pay a difference between a spot price and the strike price upon redemption of the contract, where the spot price is a current market price of the amount of commodity upon redemption;
receiving a notification that the owner of the contract redeemed the contract to obtain the specified amount of the commodity from a merchant business establishment;
responsive to the notification, facilitating payment of the difference between the spot price and the strike price to at least one of the owner of the contract and the merchant business establishment; and
charging the difference between the spot price and the strike price to the original seller of the contract or the underwriter associated therewith.

2. The method of claim 1, wherein the strike price is zero.

3. The method of claim 1, wherein facilitating the payment of the difference between the spot price and the strike price comprises:
making a payment to the merchant business establishment at the difference between the spot price and the strike price, wherein the owner of the contract received the specified amount of the commodity in exchange for redeeming the contract at the strike price.

4. The method of claim 1, wherein facilitating the payment of the difference between the spot price and the strike price comprises:
making a payment to the owner of the contract at the difference between the spot price and the strike price, wherein the owner of the contract paid the spot price to the merchant business establishment in order to receive the specified amount of the commodity.

5. The method of claim 4, wherein the notification that the owner of the contract redeemed the contract includes a proof of purchasing the specified amount of commodity by the owner of the contract from the merchant business establishment.

6. The method of claim 5, wherein the proof of purchasing the specified amount of commodity by the owner of the contract from the merchant business establishment comprises at least one of: a receipt of the purchase issued by the merchant business establishment, and information about a location associated with the redemption captured by an electronic device of the owner of the contract.

7. The method of claim 6, wherein the receipt of the purchase issued by the merchant business establishment comprises a plurality of information for verifying the purchase, the plurality of information provided by the receipt of the purchase comprising at least one of:
a geolocation of the merchant business establishment;
a timestamp indicating redemption request submission time;
a type of the commodity purchased;
a quality of the commodity purchased; and
a quantity of the commodity obtained.

8. The method of claim 1, wherein facilitating the payment of the spot price further comprises:
applying a discount to the payment of the sport price of the commodity at time of redemption.

9. The method of claim 1, further comprising:
receiving an order to trade a contract for a commodity;
determining whether there are one or more existing open orders matching the received order; and
responsive to the received order being matched by at least one existing open order, executing the trade.

10. The method of claim 9, wherein determining whether there are one or more existing open orders matching the received order is based at least in part on comparing geolocation information specified in the received order with geolocation information of the one or more existing open orders:

11. The method of claim 1, further comprising:
determining the spot price of the commodity upon redemption based on the received notification;
comparing the spot price to a market price of the commodity having comparable one or more parameters;
detecting a fraudulent transaction based on the comparing; and
responsive to a detection of the fraudulent transaction, taking remedial action on the detected fraudulent transaction.

12. The method of claim 1, further comprising:
collecting data associated with redemption of contracts for commodities;
calculating one or more commodity indices and commodity volatility indices based on the collected data;
publishing the commodity indices; and
executing contracts for commodities created based on the published commodity indices.

13. The method of claim 1, wherein the commodity is a tradable item, comprising at least one of: gasoline, diesel, electricity, natural gas, water, utilities, coal, metals, bullions, agricultural products, collectibles, a piece of real estate, and an intangible service or product.

14. The method of claim 1, further comprising:
receiving a request from the owner of the contract to convert the contract by exercising a conversion right contract on the contract, wherein the conversion right contract is a contract that enables the owner to convert one or more parameters of the contract selected from a group consisting of: the merchant business establishment from which the owner of the contract can obtain the commodity, an expiration date of the contract, strike price, a type of the commodity, and a quality of the commodity; and
responsive to the request to convert the contract, converting the contract by changing one or more of the parameters of the contract.

15. The method of claim 14, wherein the commodity conversion contract is a tradable item having a price determined by a market in which the commodity conversion contract is traded.

16. A computer-implemented method for managing a contract for a commodity, the method comprising:
maintaining in a data store information describing a contract for a commodity, the contract entitling an owner of the contract to redeem the contract to obtain a specified amount of the commodity from a merchant business establishment, the contract further obligating an original seller of the contract or an underwriter associated therewith to pay a spot price upon redemption of the contract, where the spot price is a current market price of the amount of commodity upon redemption;
receiving a notification that the owner of the contract redeemed the contract to obtain the specified amount of the commodity from a merchant business establishment;
responsive to the notification, facilitating payment of the spot price to at least one of the owner of the contract and the merchant business establishment; and
charging the spot price to the original seller of the contract or the underwriter associated therewith.

17. A computer program product for managing a contract for a commodity, the computer program product comprising a non-transitory computer-readable storage medium containing computer program code for:
maintaining in a data store information describing a contract for a commodity, the contract entitling an owner of the contract to redeem the contract to obtain a specified amount of the commodity from a merchant business establishment at a strike price, the contract further obligating an original seller of the contract or an underwriter associated therewith to pay a difference between a spot price and the strike price upon redemption of the contract, where the spot price is a current market price of the amount of commodity upon redemption;
receiving a notification that the owner of the contract redeemed the contract to obtain the specified amount of the commodity from a merchant business establishment;
responsive to the notification, facilitating payment of the difference between the spot price and the strike price to at least one of the owner of the contract and the merchant business establishment; and
charging the difference between the spot price and the strike price to the original seller of the contract or the underwriter associated therewith.

18. The computer program product of claim 17, wherein the strike price is zero.

19. The computer program product of claim 17, wherein facilitating the payment of the difference between the spot price and the strike price comprises:
making a payment to the merchant business establishment at the difference between the spot price and the strike price, wherein the owner of the contract received the specified amount of the commodity in exchange for redeeming the contract at the strike price.

20. The computer program product of claim 17, wherein facilitating the payment of the difference between the spot price and the strike price comprises:
making a payment to the owner of the contract at the difference between the spot price and the strike price, wherein the owner of the contract paid the spot price to the merchant business establishment in order to receive the specified amount of the commodity.

21. The computer program product of claim 20, wherein the notification that the owner of the contract redeemed the contract includes a proof of purchasing the specified amount of commodity by the owner of the contract from the merchant business establishment.

22. The computer program product of claim 21, wherein the proof of purchasing the specified amount of commodity by the owner of the contract from the merchant business establishment comprises at least one of: a receipt of the purchase issued by the merchant business establishment, and information about a location associated with the redemption captured by an electronic device of the owner of the contract.

23. The computer program product of claim 22, wherein the receipt of the purchase issued by the merchant business establishment comprises a plurality of information for verifying the purchase, the plurality of information provided by the receipt of the purchase comprising at least one of:
a geolocation of the merchant business establishment;
a timestamp indicating redemption request submission time;
a type of the commodity purchased;
a quality of the commodity purchased; and
a quantity of the commodity obtained.

24. The computer program product of claim 17, wherein facilitating the payment of the spot price further comprises:
applying a discount to the payment of the sport price of the commodity at time of redemption.

25. The computer program product of claim 17, the computer-readable storage medium further containing computer program code for:
receiving an order to trade a contract for a commodity;
determining whether there are one or more existing open orders matching the received order; and
responsive to the received order being matched by at least one existing open order, executing the trade.

26. The computer program product of claim 25, wherein determining whether there are one or more existing open orders matching the received order is based at least in part on comparing geolocation information specified in the received order with geolocation information of the one or more existing open orders:

27. The computer program product of claim 17, the computer-readable storage medium further containing computer program code for:
determining the spot price of the commodity upon redemption based on the received notification;
comparing the spot price to a market price of the commodity having comparable one or more parameters;
detecting a fraudulent transaction based on the comparing; and
responsive to a detection of the fraudulent transaction, taking remedial action on the detected fraudulent transaction.

28. The computer program product of claim 17, the computer-readable storage medium further containing computer program code for:
collecting data associated with redemption of contracts for commodities;
calculating one or more commodity indices and commodity volatility indices based on the collected data;
publishing the commodity indices; and
executing contracts for commodities created based on the published commodity indices.

29. The computer program product of claim 17, wherein the commodity is a tradable item, comprising at least one of: gasoline, diesel, electricity, natural gas, water, utilities, coal, metals, bullions, agricultural products, collectibles, a piece of real estate, and an intangible service or product.

30. The computer program product of claim 17, the computer-readable storage medium further containing computer program code for:
receiving a request from the owner of the contract to convert the contract by exercising a conversion right contract on the contract, wherein the conversion right contract is a contract that enables the owner to convert one or more parameters of the contract selected from a group consisting of: the merchant business establishment from which the owner of the contract can obtain the commodity, an expiration date of the contract, strike price, a type of the commodity, and a quality of the commodity; and
responsive to the request to convert the contract, converting the contract by changing one or more of the parameters of the contract.

31. The computer program product of claim 30, wherein the commodity conversion contract is a tradable item having a price determined by a market in which the commodity conversion contract is traded.

32. A computer program product for managing a contract for a commodity, the computer program product comprising a non-transitory computer-readable storage medium containing computer program code for:
maintaining in a data store information describing a contract for a commodity, the contract entitling an owner of the contract to redeem the contract to obtain a specified amount of the commodity from a merchant business establishment, the contract further obligating an original seller of the contract or an underwriter associated therewith to pay a spot price upon redemption of the contract, where the spot price is a current market price of the amount of commodity upon redemption;
receiving a notification that the owner of the contract redeemed the contract to obtain the specified amount of the commodity from a merchant business establishment;
responsive to the notification, facilitating payment of the spot price to at least one of the owner of the contract and the merchant business establishment; and
charging the spot price to the original seller of the contract or the underwriter associated therewith.
